(19) United States
(12) Patent Application Publication
(10) Pub. No.: US 2016/0233799 A1
(43) Pub. Date: Aug. 11, 2016

(54) Efficiency improver of brushless DC motor

(71) Applicant: RENUN MECHANICAL& ELETRICAL CO., LTD, Zhuji City, Zhejiang (CN)

(72) Inventor: Kewei WANG, Zhuji, Zhejiang (CN)

(21) Appl. No.: 14/381,209

(22) PCT Filed: Apr. 9, 2014
(86) PCT No.: PCT/CN2014/074985

§ 371 Date: Aug. 26, 2014

(30) Foreign Application Priority Data
Mar. 25, 2014 (CN) 201420137460.4

(51) Int. Cl. H02P 6/10; H02P 6/16; H02P 6/14

(52) U.S. Cl. CPC H02P 6/10; H02P 6/14; H02P 6/16

(57) ABSTRACT

A device for inhibiting electromagnetic torque ripples of a brushless DC motor includes: a driving circuit for driving a brushless DC motor; a sensor for detecting a rotor position of the brushless DC motor and generating a corresponding rotor position signal; a driving signal generator receiving the rotor position signal and converting the rotor position signal to a driving signal; a motor efficiency improver receiving the rotor position signal and converting the rotor position signal to a commutation control signal; and a DC power source; wherein the driving circuit superimpose the driving signal and the commutation control signal for generating a fitting signal, the fitting signal is characterized by that: a control voltage before and after a commutation position is closed, and the bridge driving circuit controls an output current, in such a manner that a stator current of the motor at the commutation position is zero.

### CROSS REFERENCE OF RELATED APPLICATION

This is a U.S. National Stage under 35 U.S.C 371 of the International Application PCT/CN2014/074985, filed Apr. 9, 2014, which claims priority under 35 U.S.C. 119(a-d) to CN 201410113711.X, filed Mar. 25, 2014, and CN 201420137460.4, filed Mar. 25, 2014.

### BACKGROUND OF THE PRESENT INVENTION

1. Field of Invention

The present invention relates to a field of motor circuit technology, and more particularly to an efficiency improver of a brushless DC (direct current) motor.

2. Description of Related Arts

Brushless DC motor is widely utilized. However, due to the defects thereof, electromagnetic torque ripple will be generated during the operation. The electromagnetic torque ripple will seriously decrease the rotation rate and rotation efficiency of the brushless DC motor, which prevents the brushless DC motor from being utilized in fields with high motor performance requirements.

The electromagnetic torque ripple is mainly caused by the following reasons:

First, when the rotor rotates to the commutation position, which means that when the center line of the magnetic pole of the rotor coincides with the center line of magnetic pole generated by the exciting current of the stator, the electromagnetic force on the rotor is the highest (under the same exciting current conditions). However, direction of the electromagnetic force is radial and is vertical to the rotation direction of the motor, which means that the electromagnetic torque is zero and the electromagnetic force will inevitably prevent the rotor from rotating.

Second, installation method of the conventional Hall Effect sensor is not able to ensure that the position information of the rotor will be sent to the control chip correctly. Little errors always happen besides the irregular pole line of the rotor. Therefore, electromagnetic torque ripple and electromagnetic resistance preventing the rotor from rotating always exist during commutating.

### SUMMARY OF THE PRESENT INVENTION

An object of the present invention is to provide an efficiency improver of a brushless DC motor for inhibiting electromagnetic torque ripples as well as electromagnetic resistance preventing the rotor from rotating caused by above reasons, and improving efficiency of the motor.

Accordingly, in order to accomplish the above object, the present invention provides a device for inhibiting electromagnetic torque ripples of a brushless DC motor, comprising:

a driving circuit for driving a brushless DC motor;

a sensor provided on the brushless DC motor for detecting a rotor position of the brushless DC motor and generating a corresponding rotor position signal;

a driving signal generator for receiving the rotor position signal and converting the rotor position signal to a driving signal, wherein a signal input terminal of the driving signal generator is connected to a position signal output terminal of the sensor, a signal output terminal of the driving signal generator is connected to a first input terminal of the driving circuit;

a motor efficiency improver for receiving the rotor position signal and converting the rotor position signal to a commutation control signal, wherein a signal input terminal of the motor efficiency improver is connected to the position signal output terminal of the sensor, a signal output terminal of the motor efficiency improver is connected to a second input terminal of the driving circuit; and

a DC power source for supplying the brushless DC motor, the sensor, the driving signal generator and the motor efficiency improver;

wherein the driving circuit superimpose the driving signal and the commutation control signal for generating a fitting signal, the driving circuit controls an output current, in such a manner that a stator current of the motor at the commutation position is zero.

Comparing to the conventional technologies, the present invention has advantages as follows:

a) By adding the motor efficiency improver, the motor efficiency improver is able to switch off the control voltage before and after the commutation position according to the rotor position signal from the Hall Effect sensor. Then the bridge driving circuit sets the stator current at the commutation position to zero, for avoiding incorrect commutation time caused by incorrect installation of the Hall Effect sensor and irregular pole line of the rotor, in such a manner that electromagnetic torque ripples as well as electromagnetic resistance preventing the rotor from rotating at the commutation position are inhibited. At the meantime, because the stator current during commutating is zero, radial electromagnetic preventing the rotor from rotating is effectively decreased, in such a manner that energy consumption is saved and the electromagnetic resistance preventing the rotor from rotating is minimized, so as to improve rotation rate and rotation efficiency of the motor.

b) By adding the motor efficiency improver, the driving signal generator is able to focus on generation of the driving signal rather than generate the driving signal while process too much internal arithmetic and correspondingly adjust the driving signal.

Therefore, according to the present invention, the rotation rate and the efficiency of the motor are improved while a control system is simplified, in such manner that system reliability is improved and a system cost is decreased.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of an efficiency improver of a brushless DC motor according to a preferred embodiment of the present invention.

FIG. 2 is a schematic view of the efficiency improver according to the preferred embodiment of the present invention.

FIG. 3 is a schematic view of a driving circuit according to the preferred embodiment of the present invention.

FIG. 4 is a timing diagram of control logic according to the preferred embodiment of the present invention.

### DETAILED DESCRIPTION OF THE PREFERRED EMBODIMENT

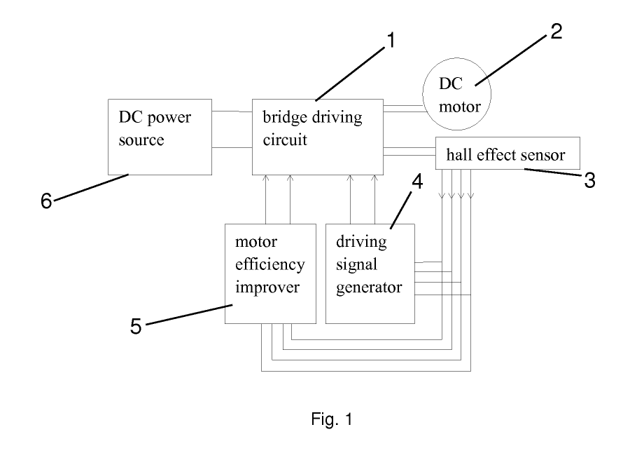

Referring to FIG. 1 of the drawings, a device for inhibiting electromagnetic torque ripples of a brushless DC motor according to a preferred embodiment of the present invention is illustrated, comprising:

a driving circuit 1 for driving a brushless DC motor 2;

a sensor 3 provided on the brushless DC motor 2 for detecting a rotor position of the brushless DC motor 2 and generating a corresponding rotor position signal;

a driving signal generator 4 for receiving the rotor position signal and converting the rotor position signal to a driving signal, wherein a signal input terminal of the driving signal generator 4 is connected to a position signal output terminal of the sensor 3, a signal output terminal of the driving signal generator 4 is connected to a first input terminal of the driving circuit 1;

a motor efficiency improver 5 for receiving the rotor position signal and converting the rotor position signal to a commutation control signal, wherein a signal input terminal of the motor efficiency improver 5 is connected to the position signal output terminal of the sensor 3, a signal output terminal of the motor efficiency improver 5 is connected to a second input terminal of the driving circuit 1; and

a DC power source 6 for supplying the brushless DC motor 2, the sensor 3, the driving signal generator 4 and the motor efficiency improver 5;

wherein the driving circuit 1 superimpose the driving signal and the commutation control signal for generating a fitting signal, the fitting signal is characterized by that: a control voltage before and after a commutation position is closed, and the driving circuit 1 controls an output current, in such a manner that a stator current of the motor 2 at the commutation position is zero.

Preferably, the driving circuit 1 is a bridge driving circuit.

Preferably, the sensor 3 is a Hall Effect sensor.

Preferably, the Hall Effect sensor continuously outputs the rotor position signal, wherein the rotor position signal is a square wave signal; the driving signal generator 4 continuously outputs the constant driving signal after receiving the rotor position signal; at a meantime, the motor efficiency improver 5 continuously outputs the commutation control signal according to the rotor position signal, wherein a cycle range of the commutation control signal is within a cycle range of a former rotor position signal.

A DC motor system according to another preferred embodiment of the present invention is illustrated, comprising:

a brushless DC motor 2;

a driving circuit 1 mounted on the brushless DC motor 2 for driving the brushless DC motor 2;

a sensor 3 provided on the brushless DC motor 2 for detecting a rotor position of the brushless DC motor 2 and generating a corresponding rotor position signal;

a driving signal generator 4 for receiving the rotor position signal and converting the rotor position signal to a driving signal, wherein a signal input terminal of the driving signal generator 4 is connected to a position signal output terminal of the sensor 3, a signal output terminal of the driving signal generator 4 is connected to a first input terminal of the driving circuit 1;

a motor efficiency improver 5 for receiving the rotor position signal and converting the rotor position signal to a commutation control signal, wherein a signal input terminal of the motor efficiency improver 5 is connected to the position signal output terminal of the sensor 3, a signal output terminal of the motor efficiency improver 5 is connected to a second input terminal of the driving circuit 1; and

a DC power source 6 for supplying the brushless DC motor 2, the sensor 3, the driving signal generator 4 and the motor efficiency improver 5;

wherein the driving circuit 1 superimpose the driving signal and the commutation control signal for generating a fitting signal, the fitting signal is characterized by that: a control voltage before and after a commutation position is closed, and the driving circuit 1 controls an output current, in such a manner that a stator current of the motor 2 at the commutation position is zero.

Preferably, the driving circuit 1 is a bridge driving circuit.

Preferably, the sensor 3 is a Hall Effect sensor.

A method for inhibiting electromagnetic torque ripples of a brushless DC motor according to another preferred embodiment of the present invention is illustrated, comprising steps of:

a) detecting a rotor position of a brushless DC motor 2 by a sensor 3, then generating a rotor position signal according to the rotor position;

b) receiving the rotor position signal and converting the rotor position signal to a driving signal by a driving signal generator 4, then inputting the driving signal into a driving circuit 1;

c) receiving the rotor position signal and converting the rotor position signal to a commutation control signal by a motor efficiency improver 5, then inputting the commutation control signal into the driving circuit 1; and

d) driving the brushless DC motor 2 by the driving circuit 1, wherein the driving circuit 1 superimpose the driving signal and the commutation control signal for generating a fitting signal, the fitting signal is characterized by that: a control voltage before and after a commutation position is closed, and the driving circuit 1 controls an output current, in such a manner that a stator current of the motor 2 at the commutation position is zero.

Preferably, the driving circuit 1 is a bridge driving circuit.

Preferably, the sensor 3 is a Hall Effect sensor.

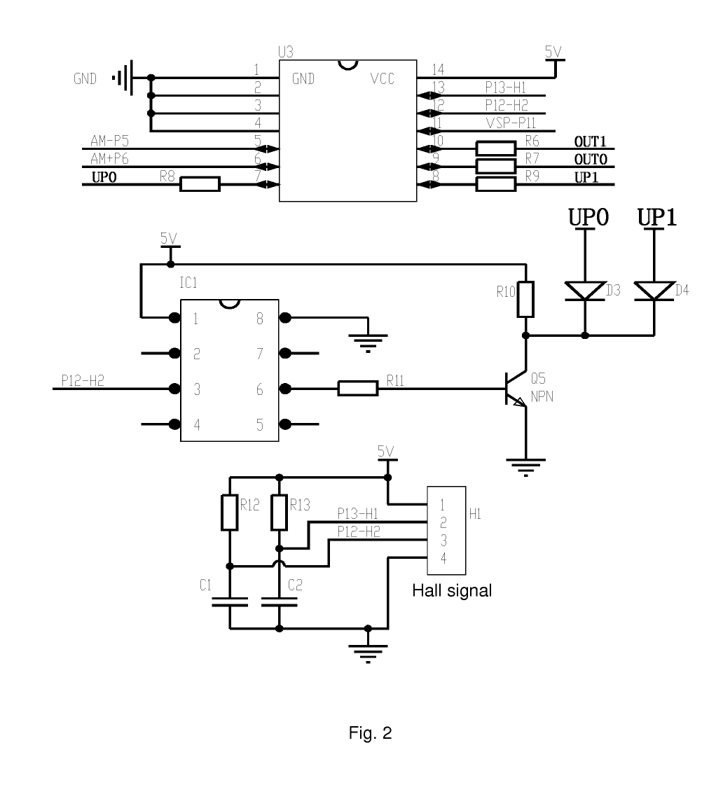

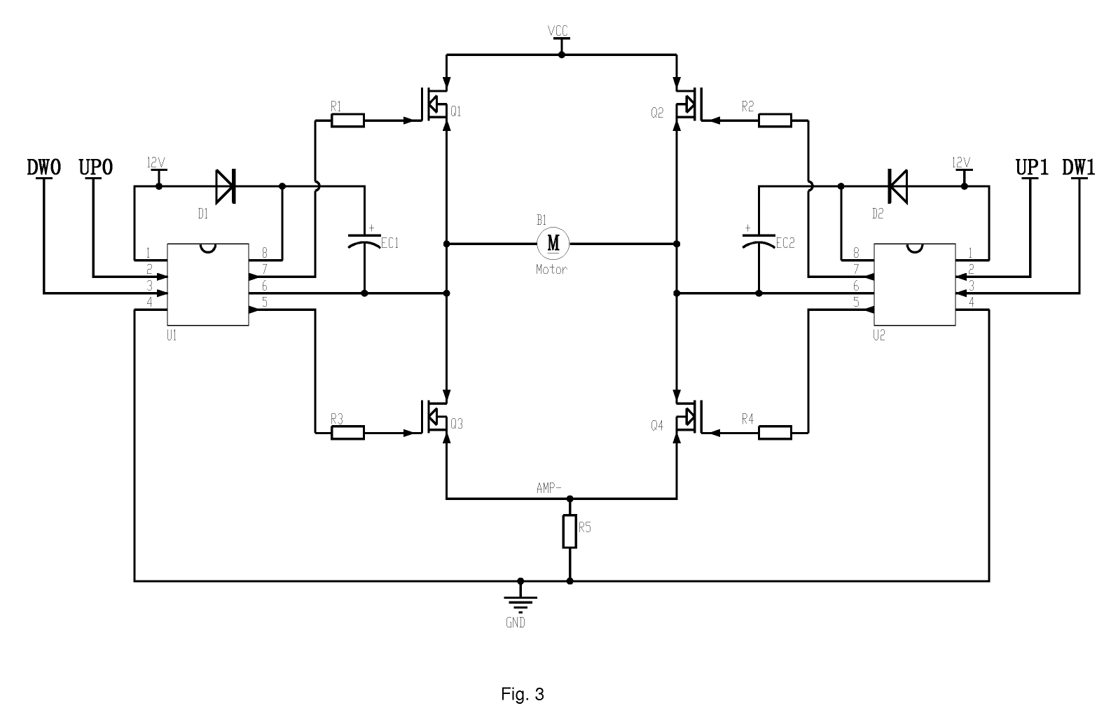

Referring to FIG. 2 and FIG. 3 of the drawings, a working process of the circuit according to the present invention is as follows. The Hall Effect sensor on the brushless DC motor transmits position information of a magnet of the rotor to an H-1 terminal of the circuit. After passing through a filtering circuit comprising R12, R13, C1 and C2, the position information is transmitted to control chips U3 and IC1, wherein the control ship U3 generates the driving signals for the bridge driving circuit, and the driving signals are divided into two groups: a first group of UP0 and DW0, and a second group of UP1 and DW1. The control chip IC1 generates corresponding motor efficiency improving signals, and the motor efficiency improving signal is outputted by a sixth pin of the control chip IC1. Because of insufficient driving capability, the motor efficiency improving signal is amplified by a triode Q5 before being transmitted to signal terminals of the UP0 and the UP1 through diodes D3 and D4 for being superimposed. Finally, a complete control signal is obtained by the driving ICs (integrated circuit) which are U1 and U2 of the bridge driving circuit. And the control signal controls the stator current of the brushless DC motor by a driving circuit comprising four switch units (Q1, Q2, Q3 and Q4), in such a manner that the stator current of the motor at the commutation position is zero, wherein the motor efficiency improving signal is depended on a rotation rate, a pole number and a load condition of the motor, and changes within the time range corresponding to the electrical angle of 0˜90°.

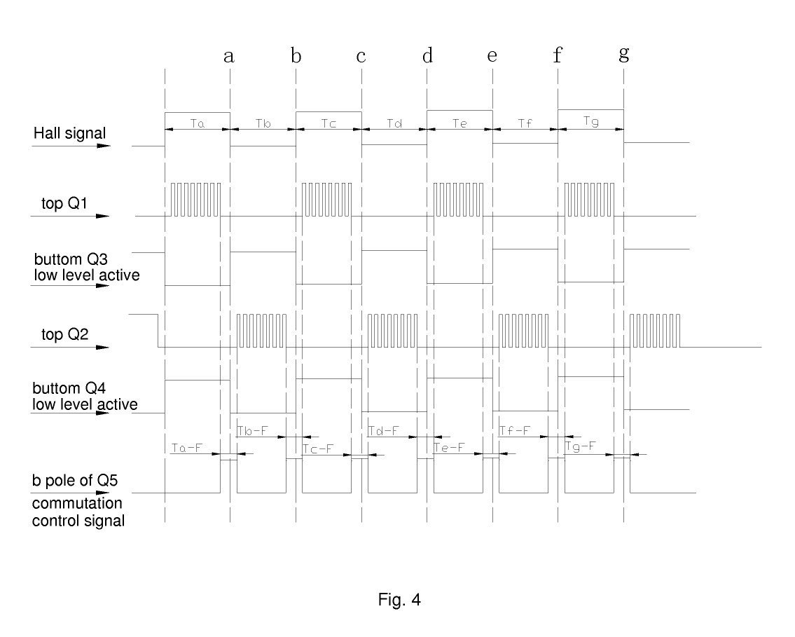

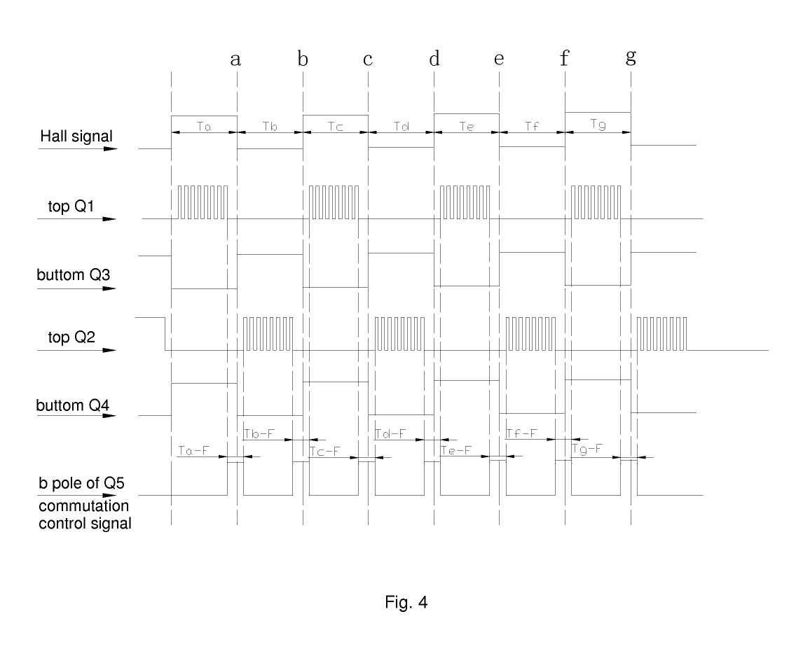

The FIG. 4 is a timing diagram of control logic according to the foregoing design. Referring to the FIG. 4, after the Hall Effect sensor continuously transmits square wave signals to the U3 and the IC1, the U3 continuously generates the constant driving control signals with a waveform of the top Q1 and a waveform of the top Q2 according to the Hall signals; and the IC1 also continuously generates the efficiency improving signals such Ta-F, Tb-F, Tc-F and Td-F according to the Hall signals, wherein a time value of the Ta-F is decided by a time value of a former Hall signal. Referring to the FIG. 4 of the drawings, a time value of the Ta-F is decided by a time value of a former Hall signal Ta. Likewise, a time value of the Tb-F is decided by a time value of a former Hall signal Tb. The commutation control signals such as the Ta-F, Tb-F, Tc-F and Td-F are all decided according to a corresponding time of a former Hall signal, and changes within a time range corresponding to an electrical angle of 0˜90°. Then the complete the waveform of the top Q1 and the waveform of the top Q2 obtained by superimposing the driving signal and the efficiency improving signal are outputted. Referring to the FIG. 4 of the drawings, before and after commutation times a, b, c and d, the waveform of the top Q1 and the waveform of the top Q2 have closed sections, and thereby the stator current of the motor at the commutation position is zero, in such a manner electromagnetic torque ripples are decreased, and a rotation rate as well as rotation efficiency of the motor are improved.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A device for inhibiting electromagnetic torque ripples of a brushless DC motor, comprising:
a driving circuit for driving a brushless DC motor;
a sensor provided on the brushless DC motor for detecting a rotor position of the brushless DC motor and generating a corresponding rotor position signal;
a driving signal generator for receiving said rotor position signal and converting said rotor position signal to a driving signal, wherein a signal input terminal of said driving signal generator is connected to a position signal output terminal of said sensor, a signal output terminal of said driving signal generator is connected to a first input terminal of said driving circuit;
a motor efficiency improver for receiving said rotor position signal and converting said rotor position signal to a commutation control signal, wherein a signal input terminal of said motor efficiency improver is connected to said position signal output terminal of said sensor, a signal output terminal of said motor efficiency improver is connected to a second input terminal of said driving circuit; and
a DC power source for supplying said brushless DC motor, said sensor, said driving signal generator and said motor efficiency improver;
wherein said driving circuit superimpose said driving signal and said commutation control signal for generating a fitting signal, said fitting signal is characterized by that: a control voltage before and after a commutation position is closed, and said driving circuit controls an output current, in such a manner that a stator current of the motor at said commutation position is zero.

2. The device, as recited in claim 1, wherein said driving circuit is a bridge driving circuit.

3. The device, as recited in claim 1, wherein said sensor is a Hall Effect sensor.

4. The device, as recited in claim 3, wherein said Hall Effect sensor continuously outputs said rotor position signal, wherein said rotor position signal is a square wave signal; said driving signal generator continuously outputs said constant driving signal after receiving said rotor position signal; at a meantime, said motor efficiency improver continuously outputs said commutation control signal according to said rotor position signal, wherein said commutation control signal is depended on a rotation rate, a pole number and a load condition of the motor, and a time value of said commutation control signal is decided by a time value of a former Hall signal, and changes within a time range corresponding to an electrical angle of 0˜90°.

5. A brushless DC motor system, comprising:
a brushless DC motor;
a driving circuit mounted on said brushless DC motor for driving said brushless DC motor;
a sensor provided on said brushless DC motor for detecting a rotor position of said brushless DC motor and generating a corresponding rotor position signal;
a driving signal generator for receiving said rotor position signal and converting said rotor position signal to a driving signal, wherein a signal input terminal of said driving signal generator is connected to a position signal output terminal of said sensor, a signal output terminal of said driving signal generator is connected to a first input terminal of said driving circuit;
a motor efficiency improver for receiving said rotor position signal and converting said rotor position signal to a commutation control signal, wherein a signal input terminal of said motor efficiency improver is connected to said position signal output terminal of said sensor, a signal output terminal of said motor efficiency improver is connected to a second input terminal of said driving circuit; and
a DC power source for supplying said brushless DC motor, said sensor, said driving signal generator and said motor efficiency improver;
wherein said driving circuit superimpose said driving signal and said commutation control signal for generating a fitting signal, said fitting signal is characterized by that: a control voltage before and after a commutation position is closed, and said driving circuit controls an output current, in such a manner that a stator current of the motor at said commutation position is zero.

6. The brushless DC motor system, as recited in claim 5, wherein said driving circuit is a bridge driving circuit.

7. The brushless DC motor system, as recited in claim 5, wherein said sensor is a Hall Effect sensor.

8. A method for inhibiting electromagnetic torque ripples of a brushless DC motor, comprising steps of:
a) detecting a rotor position of a brushless DC motor by a sensor, then generating a rotor position signal according to the rotor position;
b) receiving the rotor position signal and converting the rotor position signal to a driving signal by a driving signal generator, then inputting the driving signal into a driving circuit;
c) receiving the rotor position signal and converting the rotor position signal to a commutation control signal by a motor efficiency improver, then inputting the commutation control signal into the driving circuit; and
d) driving the brushless DC motor by the driving circuit, wherein the driving circuit superimpose the driving signal and the commutation control signal for generating a fitting signal, the fitting signal is characterized by that: a control voltage before and after a commutation position is closed, and the driving circuit controls an output current, in such a manner that a stator current of the motor at the commutation position is zero.

9. The method, as recited in claim 8, wherein the driving circuit is a bridge driving circuit.

10. The method, as recited in claim 8, wherein the sensor is a Hall Effect sensor.
